(19) United States
(12) Patent Application Publication
(10) Pub. No.: US 2004/0122691 A1
(43) Pub. Date: Jun. 24, 2004

(54) Method and device for ordering products in particular motor vehicles

(76) Inventors: Thomas Lupp, Peine (DE); Ernst-Ulrich Freitag, Braunschweig (DE); Andreas Moertzsch, Peine (DE); Dieter Burckhardt, Calberlah (DE); Ralf Nolte, Osloss (DE); Ralf Lohoff, Wahrenholz (DE); Holger Koehnecke, Bodenteich (DE); Jens Reichel, Gifhorn (DE); Olaf Goettling, Wolfsburg (DE)

Correspondence Address: KENYON & KENYON, ONE BROADWAY, NEW YORK, NY, 10004, US

(21) Appl. No.: 10/471,299

(22) PCT Filed: Jan. 30, 2002
(86) PCT No.: PCT/EP02/00929

(30) Foreign Application Priority Data
Mar. 7, 2001 (DE) 101 10 995.4
May 4, 2001 (DE) 101 21 682.3

(51) Int. Cl. G06F 17/60

(52) U.S. Cl. 705/1; 705/26

(57) ABSTRACT

A device and method of ordering products via a communication network, such as products produced at least in part upon customer request, such as motor vehicles, where a product order is input via at least one decentralized data terminal and transmitted to a central server via a communication path that is set up. The device includes a central server to which decentralized data terminals may transmit data pertaining to a product order via a communication path.

The present invention is directed to a method of ordering products via a communication network, preferably products produced at least in part upon customer request, especially motor vehicles, where a product order is input via at least one decentralized data terminal and transmitted to a central server via a communication path that is set up. Furthermore, the present invention is directed to a device for ordering products, preferably products that are produced at least in part upon customer request, especially motor vehicles, the device including a central server to which decentralized data terminals may transmit data pertaining to a product order via a communication path.

An interactive communication device for at least one supplier and/or at least one user is known from the German utility model patent DE 2000 09 547 U1, for example. The described communication system has at least one master station and a plurality of devices having at least a video screen and at least a data-input device, in each case for at least one user and/or for at least one supplier, or having data-input devices of storage media for at least one supplier, using at least one data network that interconnects the master station and the devices.

From the U.S. Pat. No. 5,960,411, a method and a device for making a purchase via a communication network is known. In the described method the potential customer transmits an order for goods to a central server via a data terminal. The order includes a customer identification as well as payment and shipment information. The central server assigns a client identifier to the client system, associating it with the order and transmitting the client identifier to the client system with an HTML document that includes an order button. Using the dial-up button, the client sends a binding order to the central server for acceptance.

Furthermore, under www.scanmarket.de/scandicar/index/Handling/Carconfig.htm (Feb. 23, 2001), a car configurator is known in which vehicles may be configured according to brand, model and equipment options via a data terminal. In addition, the desired payment method may be indicated. Upon transmission of these data and a customer identification to the central server, the supplier prepares a binding offer and sends it to the customer by mail.

It is the object of the present invention to provide a method and a device for placing orders for products that come in a wide range of variants, especially motor vehicles, via a data communication network.

The object of the present invention is achieved by the features of claims 1, 17 and 40. Advantageous developments and further refinements are described in the dependent claims.

The present invention provides a method of operating a central server able to be connected to the decentralized data terminal, where a product order is electronically sent to the central server at the supplier or at the product manufacturer via a data terminal and a data communication line. In the central server, the product order is automatically checked at least for manufacturability by comparing it against stored data. On the basis of the result, a production request for the ordered product is automatically sent to a production-control device and/or sent via call-up by way of the data communication network and/or the decentralized data terminal is automatically informed of the result of the check. The central server transmits the production request for the ordered product only if at least the manufacturability check had a positive result and a binding order is involved. The result of the check and, if appropriate, further data, are sent to the data terminal and the customer as well. If the result of the plausibility check was negative, the result is forwarded, preferably together with assistance for changing the order, so that the customer is able to repeat the order procedure. The customer is preferably also informed in those cases where the ordered product may technically be able to be manufactured, but the selected equipment does not satisfy the plausibility criteria stored in the central server for other reasons.

According to a preferred further refinement of the present invention, the central server is able to check the technical feasibility and also the manufacturing and/or delivery time (s) of the ordered product; furthermore, these may be transmitted to the decentralized data terminal that sent the product order to the central server. If the customer has indicated in his product order a delivery preference that cannot be met, the central server registers the order as binding only when it receives a notification via the decentralized data terminal that the customer has accepted the later delivery time. A similar communication procedure can run when the customer has not expressed a delivery preference.

To check the manufacturability and/or the available production capacities and/or the manufacturing and/or delivery time(s), the central server communicates with the production-control device. The production-control device stores and/or may generate pertinent data regarding the manufacturing capacities and/or the production-sequence control and thus is able to determine the manufacturing and/or delivery time(s) of a specific product and to transmit these to the central server.

An advantageous development of the present invention furthermore provides that the data pertaining to a product order received by the central server from the decentralized data terminals are forwarded to the production-control device, either directly or in processed form, the production control deriving the technical feasibility and/or manufacturing and/or delivery time(s) on the basis of the received data and forwarding these to the central server. Thus, the verification of the product order does not take place in the central server but in the production-control device.

Another further refinement of the present invention provides that data pertaining to product variants and/or optional equipment and/or variants of optional equipment are stored in the central server and a product is able to be configured at the data terminal as a function of data stored in the decentralized server, using a communication between the central server and one of the decentralized data terminals. To this end, a menu control is preferably provided at the data terminal by communicating with the central server. It may preferably be provided that video sequences of product variants and/or optional equipment and/or variants of optional equipment are stored in the central server for product configuration and may be called up and displayed by the decentralized data terminals.

According to a development of the present invention, the data of the product configured at the data terminal may be sent to the central server via the communication network. Upon request, which may be input into the data terminal, the data can be stored in the central server and/or the configured product ordered.

According to a development of the present invention, the central server stores data pertaining to products that are able to be manufactured, ordered and/or manufactured products, specifically delivery times, product descriptions and statistical data, which may be called up, directly or in processed form, via the data terminals. Thus, the customer is able, for example, to obtain an overview as to what colors of the product or which equipment variants of the product are purchased often or less often.

Furthermore, it may be provided that the central server stores data related to configurable products, in particular financing offer, new product information, equipment features and/or optional equipment for which orders may be placed, such data being able to be called up by the data terminals, either directly or in processed form. For instance, using the data terminals, it is possible to request from the central server a specific offer in connection with an ordered or configured product, which may preferably be generated and/or is generated in the central server as a function of general conditions that can be input, preferably using a menu control, via the data terminals.

To protect the customer, or customers, and the supplier, an advantageous development provides that, once a communication path has been established between the central server and one of the decentralized data terminals, a binding product order requires that a request be sent via the communication network to input data of a customer authentication and/or order authorization and/or customer identification. There are a number of options available for this purpose. For instance, the central server may send the request for order authorization and/or customer identification to the data terminal when the communication path between the central server and one of the decentralized terminals is established. Another possibility is that the central server sends the request only when defined data or functionalities are requested or only when an order is transmitted from the data terminal to the central server by the same. If the data terminal fails to transmit the customer identification and/or order authorization to the central server, the central server requests a customer authentication, i.e., the customer must request an access and/or order authorization from the central server via the data terminal. A customer authentication received by the central server is checked in the central server and, upon successful verification, an order authorization and/or customer identification are/is sent to the requesting data terminal and stored in the central server. The order authorization and/or customer identification may be valid for a single order procedure, or the central server may stipulate that it be valid for a period of time specified by the central server and/or as a function of certain verification criteria.

Another possibility of transmitting the order authorization and/or customer identification consists of manually sending the customer a generated order authorization and/or customer identification upon successful verification of the customer authentication. This increases the protection against unauthorized persons obtaining access to the order authorization and/or customer identification.

According to a development of the present invention, it is provided that a binding order of a product is able to be registered, and/or is registered, as such in the central server in connection with the transmittal of a corresponding order authorization and/or customer identification via one of the decentralized data terminals, provided the customer identification and/or order authorization transmitted by the data terminals match(es) the order authorization and/or customer identification stored in the central server.

Upon receipt of a binding order in the central server, the central server automatically forwards a production request to production control, which enters a corresponding order into the production schedule.

According to an advantageous development of the present invention, the central server automatically assigns a product and/or order identification to an incoming binding order, stores it in the central server and transmits it to the decentralized data terminal, preferably electronically. With the aid of the product and/or order identification, the decentralized data terminals are able to call up data in connection with the ordered product.

Another development provides that the central server electronically sends the customer data regarding the ordered product at defined time intervals and/or points in time, and/or when data changes, to a provided email address, for example.

Preferably, the data pertaining to the ordered product contain information about the production status of the product and/or the location of the product in the manufacture.

To generate the information, the central server communicates with the product-control device.

The data may also contain pictures and/or video sequences taken of the product. However, it is also possible to reproduce virtual images, especially 3D-images, showing the location and/or the production status of the product. In this way, the customer has the opportunity of observing the product manufacture in real time or at specific locations or at specific time intervals.

The present invention furthermore relates to a product that is directly loadable into an internal memory device of the central server and includes program-code sections by which the method steps of the present invention are executed and/or are able to be executed once the product is executed in the central server or is addressed via a data terminal that is in communicative connection with the central server.

The present invention is elucidated in greater detail in the following description on the basis of an exemplary embodiment. The appertaining drawings show:

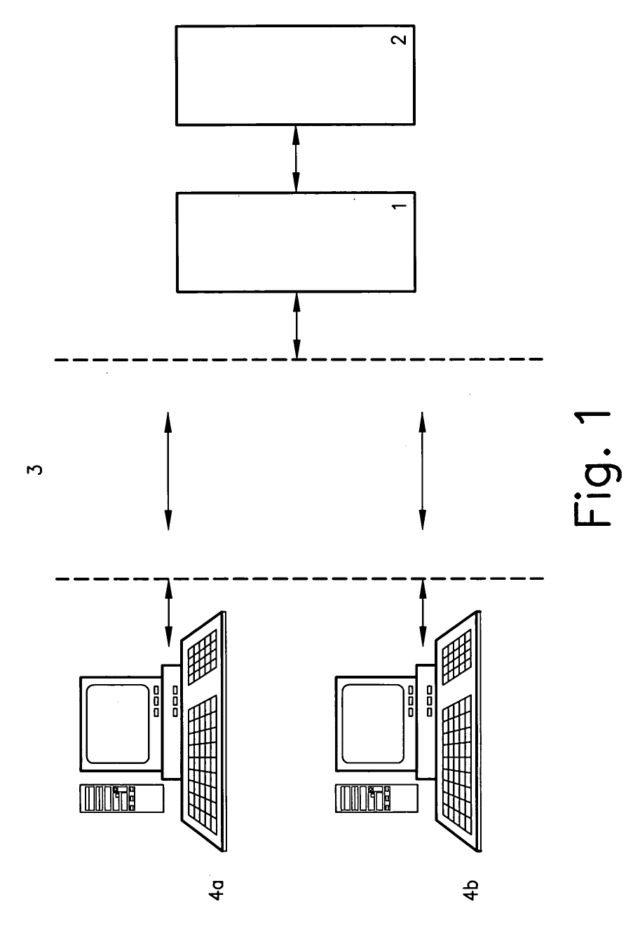

FIG. 1 a block diagram of a communication network having a device according to the present invention;

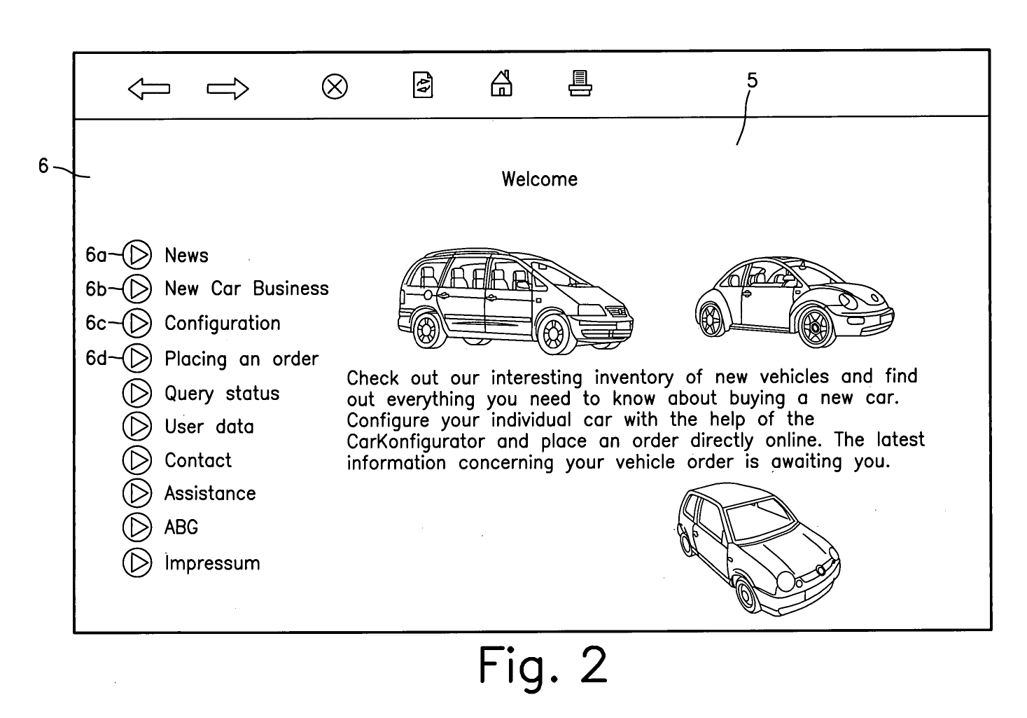

FIG. 2 a first display image on a decentralized data terminal;

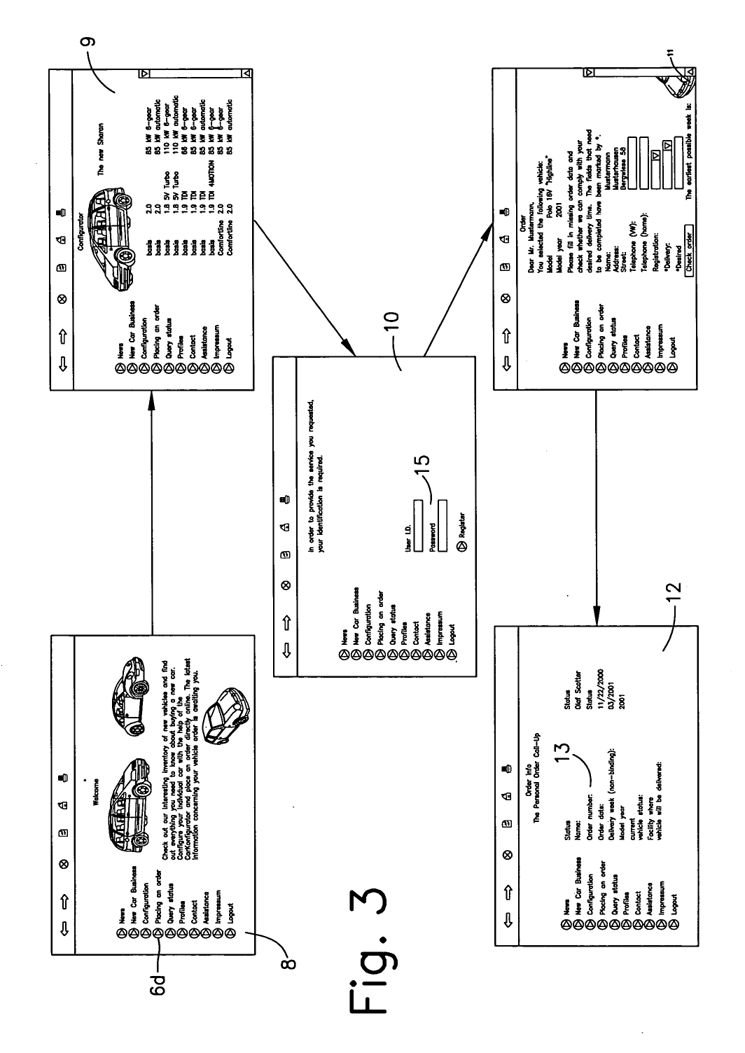

FIG. 3 a possible order sequence; and

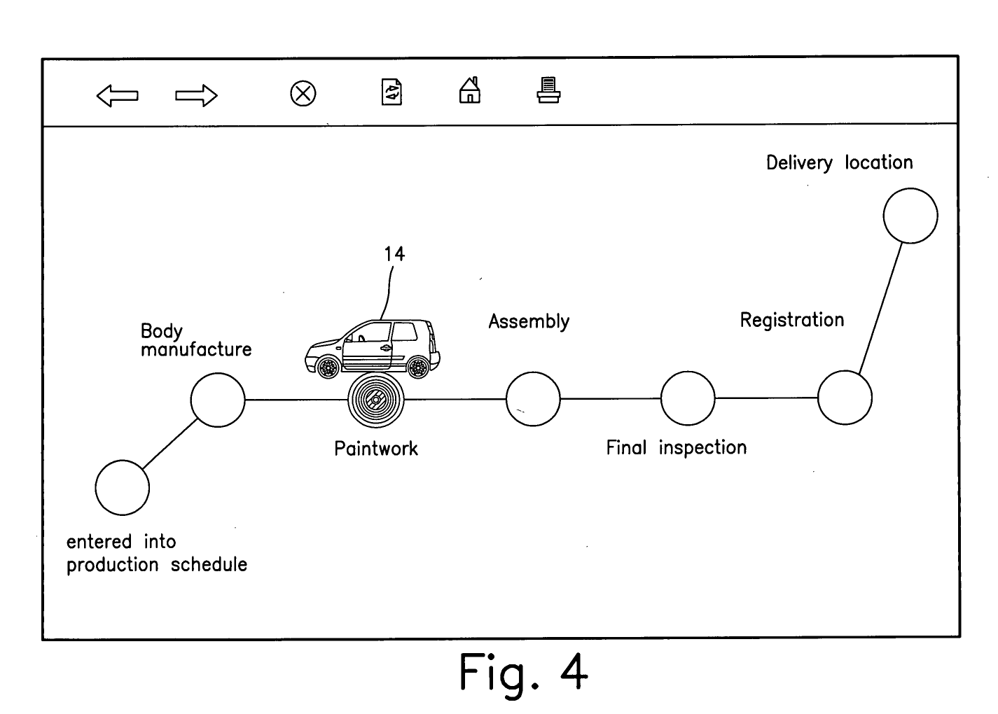

FIG. 4 a display image for the manufacturing status of the ordered vehicle.

The decentralized data terminals 4a, 4b shown in FIG. 1 may be PC's as well as permanently installed terminals in customer centers, sales exhibits or other locations. Via a communication network 3—these days this preferably is the Internet or Intranet—the individual data terminals 4a, 4b are able to establish communication paths, temporarily or permanently, to a central server 1, so that, in a dialogue between data terminals 4a, 4b and central server 1, data may be called up, for instance, requested, exchanged and/or generated. Central server 1, administering a system for the electronic ordering of products, in this case, motor vehicles, is also able to communicate, via a communication network, with at least one production-control device 2 of a manufacturer or, if products of several manufacturers can be ordered via the system for the electronic ordering of products, with at least two production-control devices of a plurality of manufacturers. Each production-control device 2, but central server 7 as well, may be made up of a number of several partial devices, which are functionally integrated here. However, it is also possible that the communication between central server 1 and individual decentralized data terminals 4a, 4b, or also the communication between the central server and a production-control device 2, is carried out via a permanent or standing communication connection.

In the exemplary embodiment, central server 1 both administers the program and also assumes some memory tasks. For instance, central server 1 not only stores data regarding vehicle variants, including engine versions as well, and data about equipment, such as colors, optional equipment data, for example winter-option packages, but also stores data in connection with ordered and/or manufactured motor vehicles, such as statistical data, and average delivery and/or manufacturing time(s) of the individual vehicle variants. In addition, central server 1 may also include data connected to a vehicle purchase, in particular financing offers and information about new and/or future products. The stored data are updated from time to time or whenever the data changes. Production-control device 2 assumes the software execution of the manufacturing processes and/or the production-sequence control during production. Furthermore, the production-control device also stores at least data pertaining to production capacities and the spare-part inventory. These data, too, are continually updated.

On the basis of FIG. 2 to, the method of the electronic ordering of a motor vehicle is described. Once the customer has established a communication connection between his decentralized data terminal 4a, 4b and central server 1, a selection menu 6 appears on the display device of data terminal 4a, 4b, via which different submenus may be called up. If, for example, menu item 6a is called up, various data pertaining to available products, such as average delivery times and manufacturer data, are generated on display device 5 of the data terminals in communication with central server 1. If menu item 6b is called up, display device 5 displays data and information that may help a customer in ordering the vehicle, if such help is required, such as overviews about which colors or engine versions were ordered how often and for which vehicles, the insurance classes of the vehicles, general financing and leasing offers.

Via menu item 6c, a vehicle may be configured for information purposes and such information stored for later functions, such as placing an order for the vehicle. In the configuration, assistance is offered to the customer via communication with central server 1 and a menu structure able to be called up. In particular, it is possible that display device 5 of the data terminal displays an image of the available vehicles and of vehicles that may be ordered from one or several manufacturers, and also the optional equipment, such as the various wheel rims offered.

Via activation of menu item 6d, the customer may initiate an electronic order both of an already configured vehicle and also of one still to be configured. FIG. 3 shows a possible ordering sequence in this connection. After calling up menu item &d of display image 8 of decentralized data terminal 4a, 4b, a display image (not shown) appears asking the customer to configure his desired vehicle. Display image 9 represents one of the menu items of the vehicle configuration. Once the desired vehicle has been completed in communication with central server 1, the customer once again has several functionalities at his disposal. For instance, the configuration may be stored, additional information for the configured product be queried, such as a financing or leasing offer, or the customer may electronically place an immediate, binding order for his desired vehicle. For this purpose he is requested via display 10 to input his customer identification 11. If the customer identification input and sent to central server 1 matches the customer identification stored in central server 1, central server 1 accepts the vehicle order and the customer is asked, via menu image 11, to check his order and to supply missing information, for example, regarding registration and delivery, and to send the order to the central server via the “check order” button. The central server forwards the order to production-control device 2 of the manufacturer in question as a binding order to be scheduled for production.

Should the manufacturer be unable to comply with the delivery time that was input and desired by the customer, production-control device 2 automatically sends a notification to central server 1, which informs the customer's decentralized data terminal and inquires whether the order should be maintained despite the later delivery time. If necessary, the communication between central server 1 and production-control device 2 may take place before display image 11 is prepared, and an earliest possible delivery time be predefined there already, which then needs to be changed only if the customer desires a later delivery time.

Once the ordered vehicle has been scheduled for production, central server 1 sends a corresponding notification 12 to data terminal 4a, 4b of the customer, the notification including an order identification or order number 13. With the aid of this order identification or order number 13, the customer is at all times able to follow the current location of his ordered vehicle, up to the point of delivery, on display device 5 of one of decentralized data terminals 4a, 4b. FIG. 4 shows a display possibility of an image called up by a customer on the data terminal. Vehicle 14, which the customer ordered, in this case is currently located at the manufacturer's painting facility. Other display possibilities, which may even include video-taping of the vehicle production and/or of the delivery of the finished product, are conceivable in this context. Additionally, central server 1 may implement an active notification, for example to an electronic mail address (email), once the ordered product reaches or passes a certain production and/or delivery stage.

The present invention is preferably to be used for the electronic ordering of products that are manufactured, at least within certain limits, upon customer request.

What is claimed is:

1. A method for the electronic ordering of products (14) via a communication network, in particular motor vehicles, in which a product order is input via decentralized data terminals (4a, 4b) and transmitted to a central server (1),
wherein the product order is checked in the central server (1) at least for manufacturability and, depending on the result, a manufacturing request for the ordered product (14) is sent to a product-control device (2) and/or the decentralized data terminal (4a, 4b) is notified of the result of the check.

2. The method as recited in claim 1,
wherein the central server (1) checks the manufacturing and/or delivery time(s) of the ordered product (14) and notifies the decentralized data terminal (4a, 4b) accordingly.

3. The method as recited in claim 2,
wherein the manufacturing and/or delivery time(s) of the ordered product (14) is/are checked in the central server (1) in communication with the product-control device (2).

4. The method as recited in claim 3,
wherein data regarding production capacities and/or production-sequence control are stored in the production-control device (2) and the production and/or delivery time(s) of the ordered product (14) is/are stipulated as a function of these data and forwarded to at least the data terminal (4a, 4b) of the customer.

5. The method as recited in one of claims 1 through 4,
wherein the central server (1) stores data of product variants and/or optional equipment and/or variants of optional equipment, and the product is configured via the at least one decentralized data terminal (4a, 4b) as a function of the data stored in the central server (1).

6. The method as recited in claim 5,
wherein a plausibility check with respect to manufacturability of the product configuration implemented via the at least one data terminal (4a, 4b) is carried out in the central server (1).

7. The method as recited in one of claims 1 through 6,
wherein the central server (1) stores data of products that can be manufactured, or ordered and/or manufactured products, in particular delivery times, product descriptions, statistical data, which are able to be called up and output via the at least one data terminal (4a, 4b).

8. The method as recited in one of claims 1 through 7,
wherein the central server (1) stores data in connection with the product, in particular financing offers, new product information, equipment features and/or optional equipment, which are able to be called up and output via the at least one data terminal (4a, 4b).

9. The method as recited in one of the preceding claims,
wherein, for a binding order of a product (14) via decentralized data terminals (4a, 4b), data of a customer authentication and/or an order authorization are sent from one of the data terminals (4a, 4b) to the central server (1), where they are checked.

10. The method as recited in claim 9,
wherein, upon satisfactory verification of the customer authentication in the central server (1), a customer identification (15) is sent to the data terminal (4a, 4b) and stored in the central server (1).

11. The method as recited in claim 9,
wherein, upon successful verification of the customer authentication in the central device (1), a manual transmission of the customer identification (15) is implemented and the customer identification stored in the central server (1).

12. The method as recited in one of claims 9 through 11,
wherein a binding order of the product (14) in connection with the notification of the customer identification (15) is registered as such in the central server (1) if the transmitted customer identification (15) matches a customer identification stored in the central server (1).

13. The method as recited in claim 12,
wherein, in the case of a binding order of a product (14), a manufacturing request is sent from the central server (1) to one of the production-control devices (2).

14. The method as recited in one of claims 9 through 13,
wherein a binding order is assigned a product and/or order identification (13) in the central server (1) and the product and/or order identification are/is sent to the data terminal (4a, 4b) or is manually sent to the customer.

15. The method as recited in claim 14,
wherein information about the product (14) may be called up from the central server (1) with the aid of the product and/or order identification (13) via at least one data terminal (4a, 4b).

16. The method as recited in claim 14,
wherein the data about the product (14) are data regarding the production status, the central server (1) communicating with the corresponding production-control device (2) to generate the data.

17. A device for ordering products, in particular motor vehicles, comprising a central server (1) to which data pertaining to a product order (14) are able to be sent by decentralized data terminals (4a, 4b) using a data communication network (3),
wherein the central server (1) is configured in such a way that the data of a product order received from the decentralized data terminals (4a, 4b) are checked at least with respect to manufacturability of the product (14) and, as a function of the result, a production request for the ordered product (14) is sent to a production-control device (2), and/or the decentralized data terminal (4a, 4b) that sent the product order to the central server (1) is notified of the result of the check.

18. The device as recited in claim 17,
wherein the technical feasibility and/or the manufacturing and/or delivery time(s) of the ordered product (14) are/is able to be checked in the central server (1) and can be transmitted to the decentralized data terminal (4a, 4b) that sent the product order to the central server (1).

19. The device as recited in claim 17 or 18,
wherein the central device (1) is configured such that the manufacturability, in particular the technical feasibility and/or the available production capacity and/or the manufacturing and/or delivery time(s) of the ordered product (14) are able to be checked in communication with the product-control device (2).

20. The device as recited in one of claims 17 through 19,
wherein data of the production capacities and/or the production-sequence control are stored in the production-control device (2), and the manufacturing and/or delivery time(s) of a specific product (14) are able to be automatically determined as a function of these data upon request by the central server (1) and able to be transmitted to the central server (1).

21. The device as recited in claim 20,
wherein the central server (1) is configured such that it forwards data of an order of a product (14) received from decentralized data terminals (4a, 4b) to the production-control device (2), directly or in processed form, the production-control device (2) deriving the technical feasibility and/or manufacturing and/or delivery time(s) on the basis of the received data and notifying the central server (1) of these, which then forwards these data to the data terminal (4a, 4b) that transmitted the product order.

22. The device as recited in one of claims 17 through 21,
wherein the central server (1) stores data of product variants and/or optional equipment and/or variants of optional equipment, and the central server (1) is designed such that a product (14) is configurable by the user via the data terminal (4a, 4b) as a function of data stored in the central server (1), via a communication path (3) able to be established between the central server (1) and one of the data terminals (4a, 4b).

23. The device as recited in claim 22,
wherein the data of the product configured at the data terminal (4a, 4b) are able to be transmitted via the communication path (3) to the central server (1) and, upon request, which may be input via the data terminal (4a, 4b), are able to be stored in the central server (1) and/or the configurable product (14) is able to be ordered.

24. The device as recited in one of claims 17 through 23,
wherein a plausibility check of the product configuration implemented via one of the data terminals (4a, 4b) with respect to technical feasibility or deliverability is able to be carried out in the central server (1).

25. The device as recited in one of claims 17 through 24,
wherein data of manufacturable, ordered and/or produced products, in particular delivery times, product descriptions, statistical data, are stored in the central server (1), which may be called up via the data terminals (4a, 4b).

26. The device as recited in one of claims 17 through 25,
wherein data in connection with configurable product are stored in the central server (1), in particular financing offers, new product information, equipment features and/or optional equipment, which are able to be called up via the data terminals (4a, 4b).

27. The device as recited in one of claims 17 through 26,
wherein data and/or offers, in particular leasing and/or financing wishes, for the product configured via one of the data terminals (4a, 4b) are able to be processed in the central server (1) and able to be transmitted to the requesting data terminal (4a, 4b).

28. The device as recited in claim 27,
wherein data and/or offers are selectable via the data terminal (4a, 4b) and are able to be transmitted to the central server (1) as an order, together with a binding product order, via an establishable communication path (3) and are able to be processed in the central server (1) in connection with the product order.

29. The device as recited in one of claims 17 through 28,
wherein the central server (1) is designed in such a way that, for the binding ordering of products (14), a request may be sent from the central server (1) to one of the data terminals (4a, 4b) that has established a communication path (3) to the central server (1), to input data of a customer authentication and/or an order authorization and/or customer identification (15).

30. The device as recited in claim 29,
wherein the central server (1) is designed such that an incoming customer authentication is checked and/or is able to be checked and, following a successful verification of the customer authentication, an order authorization and/or customer identification (15) are/is able to be transmitted and/or are/is transmitted to the requesting data terminal (4a, 4b) and are/is able to be stored and/or are/is stored in the central server (1).

31. The device as recited in claims 29 through 30,
wherein the central server (1) is designed such that an incoming customer authentication is checked and/or is able to be checked and, following a successful verification of the customer authentication, a customer identification (15) is able to be generated and/or is generated, and a manual transmission to the customer is able to be initiated and/or is initiated, and is able to be stored and/or is stored in the central server (1).

32. The device as recited in one of claims 29 through 31,
wherein the central server (1) is designed such that a binding order of the product (14) in combination with the transmission of the customer identification (15) via one of the data terminals (4a, 4b) is able to be registered and/or is registered as such in the central server (1), when the customer identification (15) transmitted by the data terminal (4a, 4b) matches a customer identification (15) stored in the central server (1).

33. The device as recited in claim 32,
wherein in the case of a binding order of a product (14), a manufacturing request is able to be electronically transmitted and/or is electronically transmitted by the central server (1) to the production-control device (2).

34. The device as recited in one of claims 29 through 31,
wherein the central server (1) is designed such that a product and/or order identification (13) is able to be assigned and/or is assigned to an incoming binding order of a product (14), and the product and/or order identification (13) is able to be electronically transmitted and/or is electronically transmitted to the data terminal (4a, 4b) or is able to be manually forwarded and/or is manually forwarded to the customer.

35. The device as recited in claim 34,
wherein information about the ordered product (14) may be called up from the central server (1) via the data terminals (4a, 4b) with the aid of the product and/or order identification (13).

36. The device as recited in one of claims 32 through 35,
wherein the central server (1) is designed such that data about the bindingly ordered product (14) are automatically able to be electronically transmitted and/or are electronically transmitted to the customer.

37. The device as recited in claim 36,
wherein the data is able to be transmitted and/or is transmitted from the central server (1) at defined time intervals and/or points in time and/or upon a data change.

38. The device as recited in one of claims 35 through 37,
wherein the data about the bindingly ordered product (14) are data about the production status and/or the location of the product, the central server (1) communicating with the production-control device (2) to generate the data.

39. The device as recited in one of claims 35 through 38,
wherein the central server (1) is configured such that the data of a bindingly ordered product (14) called up via the data terminals (4a, 4b) are graphically displayed by the data terminals (4a, 4b), in particular in 3D form and/or as video sequences.

40. A software program product which can be loaded directly into an internal memory of the central server (1) and includes program sections with which the steps of the method according to one of claims 1 through 16 are executed and/or are able to be executed when the program product is running in the central server (1).
